(19) United States
(12) Patent Application Publication
(10) Pub. No.: US 2026/0030708 A1
(43) Pub. Date: Jan. 29, 2026

(54) URBAN FLOODING PREVENTION METHOD, APPARATUS, DEVICE, AND STORAGE MEDIUM

(71) Applicant: Tongji University, Shanghai (CN)

(72) Inventors: Tao TAO, Shanghai (CN); Wen ZHU, Shanghai (CN); Xiaoyu MA, Shanghai (CN); Jiaying WANG, Shanghai (CN); Kunlun XIN, Shanghai (CN); Hexiang YAN, Shanghai (CN)

(73) Assignee: Tongji University, Shanghai (CN)

(21) Appl. No.: 19/177,656

(22) Filed: Apr. 14, 2025

(30) Foreign Application Priority Data
May 24, 2024 (CN) 202410651864.3

(51) Int. Cl. G06Q 50/26; E03F 5/10; G06N 3/0455

(52) U.S. Cl. CPC G06Q 50/265; G06N 3/0455; E03F 5/107

(57) ABSTRACT

An urban flooding prevention method includes: inverting the global water depth and the flow rate of the rainwater system, generating the urban flooding inundation map and the binary flooded grid at the monitoring time, and performing a rationality check of the global water depth of the rainwater system, the urban flooding inundation map and the binary flooded grid, performing a fusion processing based on the hydraulic connection between the 1D node and the 2D ground to obtain a label, and generating a new data set according to the label and the forecast rainfall, mixing the historical data set and the new data set to obtain a mixed data set, and using the updated model to predict the urban flooding, according to the prediction results, determining the early warning level of urban flooding, so as to generate the drainage scheme, and regulating the corresponding drainage facilities according to the drainage scheme.

### CROSS REFERENCE TO THE RELATED APPLICATIONS

This application is based upon and claims priority to Chinese Patent Application No. 202410651864.3, filed on May 24, 2024, the entire contents of which are incorporated herein by reference.

### TECHNICAL FIELD

The invention relates to the technical field of rainwater systems, particularly, an urban flooding prevention method, an apparatus, a device, and a storage medium.

### BACKGROUND

With the rise in extreme weather events and the swift expansion of urban areas, the issue of urban flooding during rainstorms has significantly disrupted the city's normal operations and compromised the safety of residents' lives and property. Consequently, to mitigate the impact of flooding and minimize the damage it causes, the early warning technology for urban flooding has increasingly garnered attention. As advanced technologies such as big data analysis, artificial intelligence, and machine learning have progressed, a data-driven model utilizing deep learning architectures has entered the research domain of urban flooding warning systems. Previous literature and patents have introduced a simulation method for rainfall runoff and a coupling confluence process that is one-dimensional and two-dimensional, based on large-scale datasets, for predicting urban flooding. This approach addresses the issues of low computational efficiency and inadequate real-time performance of traditional mechanistic models. Nonetheless, the predictive outcomes of urban flooding from data-driven models still hinge on the reliability of numerical simulations, and the practical application often exhibits a poor fit with observational data. This discrepancy leads to suboptimal effectiveness in urban flooding prevention strategies based on these predictive results.

### SUMMARY

The embodiment of the invention provides an urban flooding prevention method, apparatus, device, and storage medium.

In the first aspect, the embodiment of the invention provides an urban flooding prevention method, including:
constructing a water depth and flow generation model of a rainwater system, and based on the water depth and flow generation model of the rainwater system, inverting a global water depth and a global flow of a rainwater system according to a forecast rainfall and a water depth of a water depth monitoring point and a flow of the flow monitoring point;
constructing a flood depth compensation model, and based on the flood depth compensation model, combined with a flood depth of a flood depth monitoring point at the monitoring time and an output of a trained urban flooding prediction model, generating an urban flooding inundation map and a binary flooded grid at the monitoring time;
constructing a generated data fusion model, and based on the generated data fusion model, performing a rationality check for the global water depth, the urban flooding inundation map, and the binary flooded grid of the rainwater system, and performing a fusion processing based on a hydraulic connection between a 1D node and a 2D ground to obtain a label;
according to the label and the forecast rainfall, generating a new data set, and mixing a historical data set and a new data set to obtain a mixed data set, updating parameters of the urban flooding prediction model on the mixed data set;
using the urban flooding prediction model with updated parameters to predict the urban flooding, and determining an early warning level of urban flooding according to a prediction result of the urban flooding;
according to the early warning level of the urban flooding, generating a drainage scheme, and regulating a corresponding drainage facility according to the drainage scheme.

In some implementations of the first aspect, constructing the water depth and flow generation model of the rainwater system, including:
based on a conditional variational autoencoder and a similarity representation, constructing the water depth and flow generation model of the rainwater system; where the water depth and flow generation model includes two conditional variational autoencoders, denoted as CVAE-1 and CVAE-2, respectively, and the network structures are consistent, a definition of similarity representation is that the encoders in CVAE-1 and CVAE-2 learn similar coding representations in the same rainfall event;
an update strategy in the water depth and flow generation model of the rainwater system includes:
updating CVAE-1 according to the forecast rainfall and the water depth of the water depth monitoring point and the flow of the flow monitoring point, and obtaining the coding representation of CVAE-1;
a coding of CVAE-1 is expressed as the coding constraint of CVAE-2, and updating CVAE-2 iteratively, specifically, inputting the coding representation of CVAE-1 as the coding constraint of CVAE-2 into a decoder after an initialization weight is loaded in CVAE-2 to generate a predicted value, so as to complete an initial label under the forecast rainfall and serve as an input of a next iteration step.

In some implementations of the first aspect, an error compensation in the flood depth compensation model includes:

if a model prediction error of the flood depth of each point in a connected flooded area is consistent, compensating an error term between the flood depth of the flood depth monitoring point and the output of the urban flooding prediction model to a simulation result of each flooded point, and obtaining a preliminary compensated urban flooding inundation map of the flood depth monitoring point;
re-determining a flood borderline of the preliminary compensated urban flooding inundation map, and performing a secondary compensation for borderline points;
weighting and summing compensation results of the error terms of different flood depth monitoring points at any flooded point to estimate a final compensated inundation map.

In some implementations of the first aspect, the rationality check in the generated data fusion model includes:
checking a corresponding relationship between a water depth of the 1D node reconstructed by the water depth and flow generation model and a 2D flood depth at the node generated by the flood depth compensation model, including:

If the water depth of the node is higher than a maximum depth of the node, it is considered an overflow in the node, and a ground 2D label of a corresponding coordinate of the node should be flooded; if a flood depth at a node coordinate is 0, no overflow should be in the node, showing that the water depth of the node is less than the maximum depth of the node.

In some implementations of the first aspect, mixing the historical data set and the new data set to obtain the mixed data set, including:
performing a systematic sampling for the historical data set and a repeated sampling for the new data set;
mixing a systematic sampling result with a repeated sampling result to obtain the mixed data set.

In some implementations of the first aspect, updating parameters of the urban flooding prediction model on the mixed data set, including:
retaining a structure and an initial weight of the urban flooding prediction model by using the continuous learning model updating strategy, and updating the parameters of the urban flooding prediction model on the mixed data set.

In the second aspect, the embodiment of the invention provides an urban flooding prevention apparatus, including:
a first construction module, the first construction module is used to construct the water depth and flow generation model of the rainwater system, based on the water depth and flow generation model of the rainwater system, the global water depth and the global flow of the rainwater pipe network are inverted according to the forecast rainfall and the water depth of the water depth monitoring point and the flow of the flow monitoring point;
a second construction module, the second construction module is used to construct the flood depth compensation model, based on the flood depth compensation model, combined with the flood depth of the flood depth monitoring point at the monitoring time and the output of the trained urban flooding prediction model, the urban flooding inundation map and the binary flooded grid at the monitoring time are generated;
a third construction module, the third construction module is used to construct the generated data fusion model, based on the generated data fusion model, the rationality check for the global water depth and urban flooding inundation map and the binary flooded grid of the rainwater system is performed, and the fusion processing based on the hydraulic connection between the 1D node and the 2D ground is performed to obtain the label;
a parameter update module, the parameter update module is used to generate the new data set according to the label and forecast rainfall, the historical data set and the new data set are mixed to obtain the mixed data set, and the parameters of the urban flooding prediction model are updated on the mixed data set;
an urban flooding warning module, the urban flooding warning module is used to predict urban flooding by using the urban flooding prediction model with updated parameters, and the early warning level of the urban flooding is determined according to the prediction result of the urban flooding;
a facility regulating module, the facility regulating module is used to generate a drainage scheme according to the early warning level of the urban flooding, and to regulate the corresponding drainage facility according to the drainage scheme.

In the third aspect, the embodiment of the invention provides an electronic device, including: at least one processor; and a memory communicating with at least one processor; a memory stores an instruction that can be executed by at least one processor, and the instruction is executed by at least one processor to enable at least one processor to perform the method described above.

In the fourth aspect, the embodiment of the invention provides a non-instantaneous computer readable storage medium that stores the computer instruction, the computer instruction are used to enable the computer to perform the method described above.

In the embodiment of the invention, the parameters of the urban flooding prediction model can be updated by constantly adding new training data, and the real-time prediction of urban flooding can be performed by using the urban flooding prediction model with updated parameters, so that the urban flooding prediction results of the urban flooding prediction model are more suitable for the actual observation situation, and then the early warning level of the urban flooding is determined based on the urban flooding prediction results, so as to generate the drainage scheme, and regulate the corresponding drainage facilities according to the scheme, so as to improve the control effect of the urban flooding.

It should be understood that the content described in the content section of the invention is not a key or important feature intended to limit the embodiment of the invention, nor is it intended to limit the scope of the invention. Other features of the present invention will be easily understood through the following description.

### BRIEF DESCRIPTION OF THE DRAWINGS

Combined with the attached figures and concerning the following detailed instructions, the above and other characteristics, advantages, and aspects of each embodiment of the invention will become more obvious. The attached figures are used to better understand the scheme and do not constitute a restriction on the invention, the same or similar attached figure marks represent the same or similar elements, where:

FIG. 1 and FIG. 2 are flowcharts of the urban flooding prevention method provided by the embodiment of the invention.

FIG. 3 is a schematic diagram of the topology of the rainwater system in the JD area of the embodiment of the invention;

FIG. 4 is a schematic diagram of the monitoring point layout in the JD area of the embodiment of the invention;

FIG. 5 is a structural diagram of the urban flooding prediction model RP-SN in the embodiment of the invention;

FIG. 6 is a schematic diagram of the CVAE-1 structure in the water depth and flow generation model of the rainwater system in the embodiment of the invention.

FIG. 7 is a training effect evaluation diagram of the water depth and flow generation model in the embodiment of the invention;

FIG. 8 is a training effect evaluation diagram of the water depth and flow generation model in the embodiment of the invention;

FIG. 9 is an evaluation box diagram of the update effect of the water depth and flow generation model in the embodiment of the invention;

FIG. 10 is an evaluation box diagram of the update effect of the water depth and flow generation model in the embodiment of the invention;

FIG. 11 is a schematic diagram of the flood borderline treatment in the flood depth compensation model in the embodiment of the invention;

FIG. 12 is a comparison diagram between the compensated inundation depth and the observed value at the flood depth monitoring point f1 in Rainfall example 3 and Rainfall example 7 in the embodiment of the invention;

FIG. 13 is a comparison diagram between the compensated inundation map and the simulation map at some moments in the updated dataset of Rainfall example 7 of the embodiment of the invention;

FIG. 14 is a comparison diagram of the 1D water depth reconstruction value of some overflow points and non-overflow points in the embodiment of the invention and the 2D flood depth compensation value and fusion value at the ground corresponding to the node;

FIG. 15 is an evaluation box diagram of the effect comparison before and after the RP-SN parameter update of the urban flooding prediction model in the embodiment of the invention;

FIG. 16 is a structural diagram of an urban flooding prevention device provided by the embodiment of the invention;

FIG. 17 is a structural diagram of an exemplary electronic device that can implement the embodiment of the invention.

### DETAILED DESCRIPTION OF THE EMBODIMENTS

In order to make the purpose, technical scheme, and advantages of the embodiment of the invention more clear, the following will describe the technical scheme of the embodiment of the invention clearly and completely in combination with the attached figures of the embodiment of the invention. Obviously, the described embodiment is part of the embodiments of the invention. Based on the embodiments in the invention, all other embodiments obtained by ordinary technicians in this field without making creative labor belong to the scope of protection of the invention.

In addition, the term and/or in this invention is only a description of the relationship between the associated objects, indicating that there can be three relationships, for example, A and/or B, which can be expressed as follows: there is A alone, there are A and B at the same time, and there is B alone. In addition, the character/in this invention generally indicates that the related object is a kind of or relationship.

Given the problems in the background technology, the embodiment of the invention provides an urban flooding prevention method, an apparatus, a device, and a storage medium. The parameters of the urban flooding prediction model can be updated by constantly adding new training data, and the real-time prediction of urban flooding can be performed by using the urban flooding prediction model with updated parameters, so that the urban flooding prediction results of the urban flooding prediction model are more suitable for the actual observation situation, and then the early warning level of the urban flooding is determined based on the urban flooding prediction results, so as to generate the drainage scheme, and regulate the corresponding drainage facilities according to the scheme, so as to improve the control effect of the urban flooding.

The urban flooding prevention method, apparatus, device, and storage medium provided by the embodiment of the invention are described in detail through specific embodiments in the following.

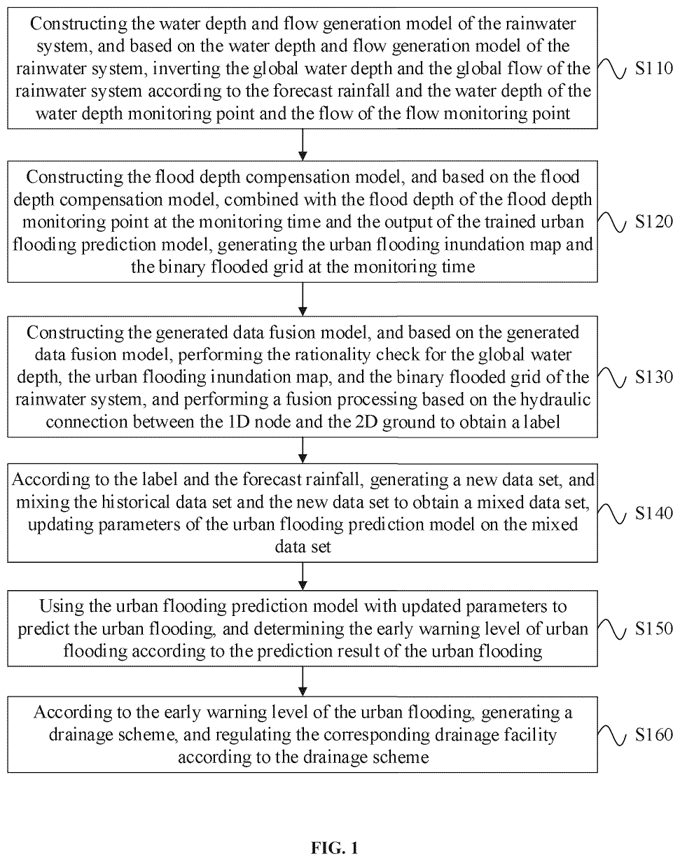

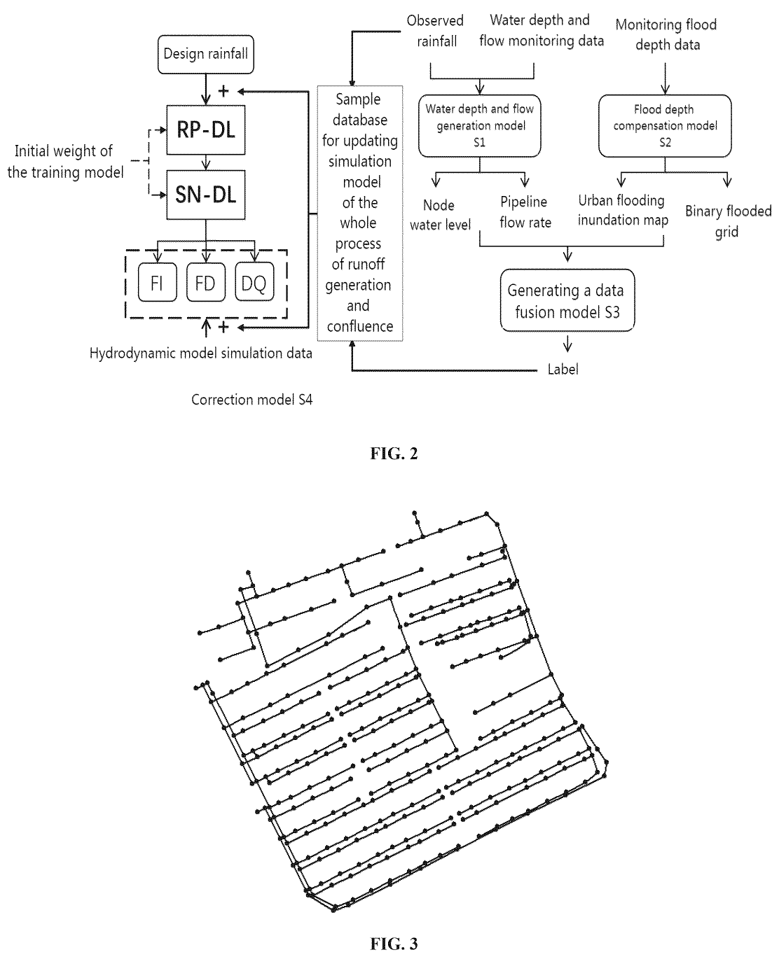

FIG. 1-FIG. 2 are the flowcharts of the urban flooding prevention method provided by the embodiment of the invention, as shown in FIG. 1-FIG. 2, the urban flooding prevention method can include the following steps:

S110, the water depth and flow generation model of the rainwater system was constructed, and based on the water depth and flow generation model of the rainwater system, the global water depth and the global flow of the rainwater system were inverted according to the forecast rainfall and the water depth of the water depth monitoring point and the flow of the flow monitoring point.

S120, the flood depth compensation model was constructed, and based on the flood depth compensation model, combined with the flood depth of the flood depth monitoring point at the monitoring time and the output of the trained urban flooding prediction model, generating the urban flooding inundation map and the binary flooded grid at the monitoring time were generated.

S130, the generated data fusion model was generated, and based on the generated data fusion model, the rationality check for the global water depth, the urban flooding inundation map, and the binary flooded grid of the rainwater system was performed, and the fusion processing was performed based on the hydraulic connection between the 1D node and the 2D ground to obtain the label;

S140, according to the label and the forecast rainfall, the new data set was generated, and the historical data set and the new data set were mixed to obtain the mixed data set, the parameters of the urban flooding prediction model were updated on the mixed data set;

S150, the urban flooding prediction model with updated parameters was used to predict the urban flooding, and the early warning level of the urban flooding was determined according to the prediction result of the urban flooding;

S160, the drainage scheme was generated according to the early warning level of the urban flooding, and the corresponding drainage facility was regulated according to the drainage scheme.

In order to facilitate further understanding, the above steps are described in the following in combination with specific embodiments:

FIG. 3 is the schematic diagram of the topology of the rainwater system in the JD area of the embodiment of the invention, as shown in FIG. 3, the dots were the nodes of the rainwater system, and the line segment between the two nodes was the pipe segment, the rainwater system in the JD area included 340 nodes and 340 pipe segments, and 4 outlets were included in 340 nodes.

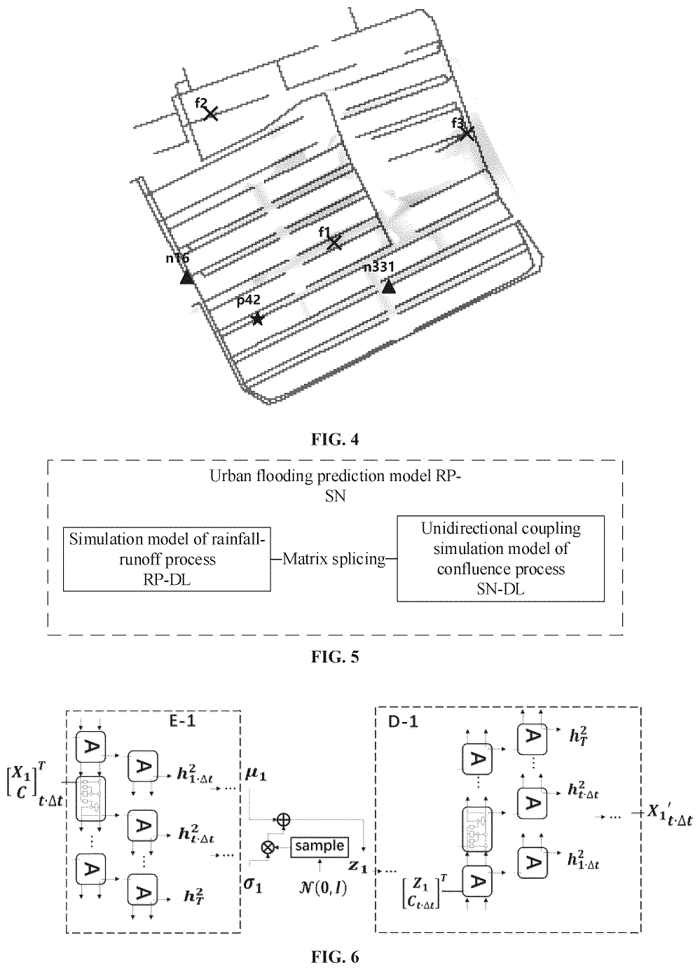

FIG. 4 is the schematic diagram of the monitoring point layout in the JD area of the embodiment of the invention; as shown in FIG. 4, there were three flood depth monitoring points in the JD area, numbered f1, f2, f3; there were two water depth monitoring points in the rainwater system, numbered n16 and n331; and there was a rainwater system flow monitoring point, numbered p42.

FIG. 5 is the structural diagram of the urban flooding prediction model RP-SN in the embodiment of the invention; as shown in FIG. 5, the urban flooding prediction model RP-SN included the simulation model of rainfall runoff process RP-DL and the unidirectional coupling simulation model of confluence process SN-DL. The input of the urban flooding prediction model RP-SN was the rainfall time series R=[r_{1·Δt}, r_{2·Δt}, . . . , r_{t·Δt}, . . . , r_{T}]^{T} and the terrain elevation data DEM, the labels included two categories: one was the two-dimensional label, the urban flooding inundation map time series FD and the binary flooded grid time series FI, the label value in FI was 0 or 1, which corresponded to FD one by one: if

$${fd}_{t \cdot Δ t}^{z} > 0 ,$$

then

$${fi}_{t \cdot Δ t}^{z} = 1 ; otherwise , {fi}_{t \cdot Δ t}^{z} = 0 ;$$

the other was one-dimensional label, the rainwater system node water depth and pipeline flow time series DQ. The label matrix form was as follows:

$$FD = {[ \begin{matrix}{fd}_{1 \cdot Δ t}^{1} & … & {fd}_{t \cdot Δ t}^{1} & … & {fd}_{T}^{1} \\ ⋮ & ⋱ & & & ⋮ \\ {fd}_{1 \cdot Δ t}^{z} & & {fd}_{t \cdot Δ t}^{z} & ⋱ & {fd}_{T}^{z} \\ ⋮ & … & & … & ⋮ \\ {fd}_{1 \cdot Δ t}^{Z} & & {fd}_{t \cdot Δ t}^{Z} & & {fd}_{T}^{Z}\end{matrix} ]}^{T} \qquad ( 1 )$$

$$FI = {[ \begin{matrix}{fi}_{1 \cdot Δ t}^{1} & … & {fi}_{t \cdot Δ t}^{1} & … & {fi}_{T}^{1} \\ ⋮ & ⋱ & & & ⋮ \\ {fi}_{1 \cdot Δ t}^{z} & & {fi}_{t \cdot Δ t}^{z} & ⋱ & {fi}_{T}^{z} \\ ⋮ & … & & … & ⋮ \\ {fi}_{1 \cdot Δ t}^{Z} & & {fi}_{t \cdot Δ t}^{Z} & & {fi}_{T}^{Z}\end{matrix} ]}^{T} \qquad ( 2 )$$

$$DQ = {[ \begin{matrix}{d}_{1 \cdot Δ t}^{1} & … & {d}_{t \cdot Δ t}^{1} & … & {d}_{T}^{1} \\ ⋮ & ⋱ & & & ⋮ \\ {{d}_{1 \cdot Δ t}^{n}}_{} & & {d}_{t \cdot Δ t}^{n} & ⋱ & {d}_{T}^{n} \\ ⋮ & … & & … & ⋮ \\ {d}_{1 \cdot Δ t}^{N} & & {d}_{t \cdot Δ t}^{N} & & {d}_{T}^{N} \\ {q}_{1 \cdot Δ t}^{1} & … & {q}_{t \cdot Δ t}^{1} & … & {q}_{T}^{1} \\ ⋮ & ⋱ & & & ⋮ \\ {q}_{1 \cdot Δ t}^{m} & & {q}_{t \cdot Δ t}^{m} & ⋱ & {q}_{T}^{m} \\ ⋮ & … & & … & ⋮ \\ {q}_{1 \cdot Δ t}^{M} & & {q}_{t \cdot Δ t}^{M} & & {q}_{T}^{M}\end{matrix} ]}^{T} \qquad ( 3 )$$

where Z denotes the total number of grids; the unit is m; fd denotes the flood depth, the unit is m; fi denotes the binary flooded grid, the unit is m; d denotes the node water depth, the unit is m; q denotes the pipeline flow, the unit is m³/s; N denotes the total number of nodes; M denotes the total number of pipelines.

In S110, the water depth and flow generation model of the rainwater system was constructed based on the water depth and flow generation model of the rainwater system. where the water depth and flow generation model included two conditional variational autoencoders, which were denoted as CVAE-1 and CVAE-2, respectively, and their network structures were consistent, the definition of similarity representation is that the encoders in CVAE-1 and CVAE-2 learn similar coding representations in the same rainfall event.

The update strategies in the water depth and flow generation model of the rainwater system included:
(1) The CVAE-1 was updated according to the forecast rainfall and the water depth of the water depth monitoring point and the flow of the flow monitoring point, and the coding representation of the CVAE-1 was obtained.
(2) The coding of CVAE-1 was expressed as the coding constraint of CVAE-2, and CVAE-2 was iteratively updated, specifically, the coding representation of CVAE-1 was input as the coding constraint of CVAE-2 into the decoder after the initialization weight was loaded in CVAE-2 to generate the predicted value, so as to complete the initial label under the forecast rainfall and serve as the input of the next iteration step.

In a specific example, CVAE-1 and CVAE-2 were constructed and trained respectively under the condition of designing rainfall time series, the network structures of CVAE-1 and CVAE-2 were consistent.

FIG. 6 is the schematic diagram of the CVAE-1 structure in the water depth and flow generation model of the rainwater system in the embodiment of the invention, as shown in FIG. 6, X₁ and X₁′ denotes the input and reconstructed monitoring matrices, condition Condition(C) denotes the rainfall, μ₁ and σ₁ are the mean and standard deviations of the distribution Z₁ learned by the encoder E-1, z₁ is the sampling value from the distribution Z₁ for decoding input, the subscript of the symbol in the corresponding CVAE-2 is 2.

In the training process, in addition to the optimization goal of the general conditional variational autoencoder, during the CVAE-2 training, the information loss when minimizing the Z₁ approximate fitting distribution Z₂ with the coding representation was added, and the coding representation Z₁ learned in CVAE-1 was used as the constraint of the coding representation in CVAE-2.

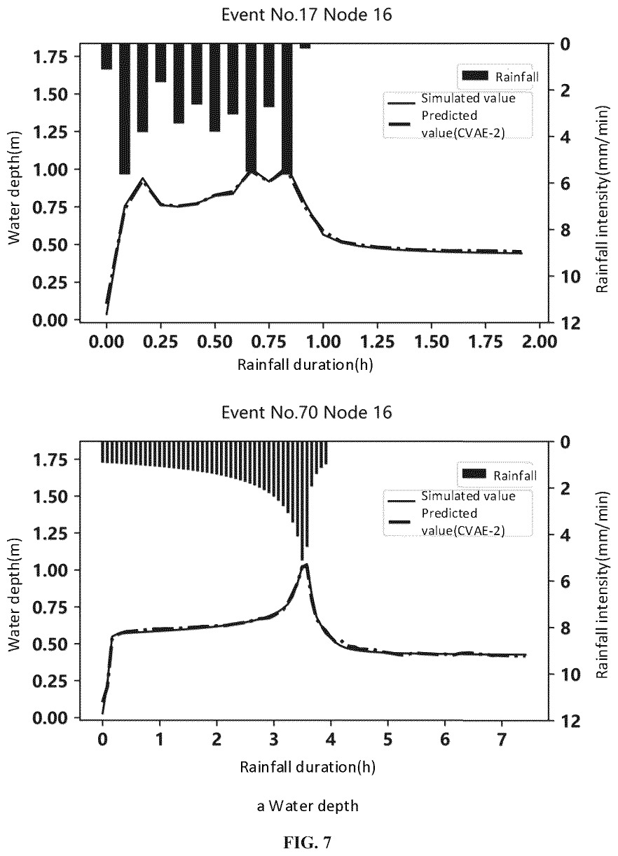

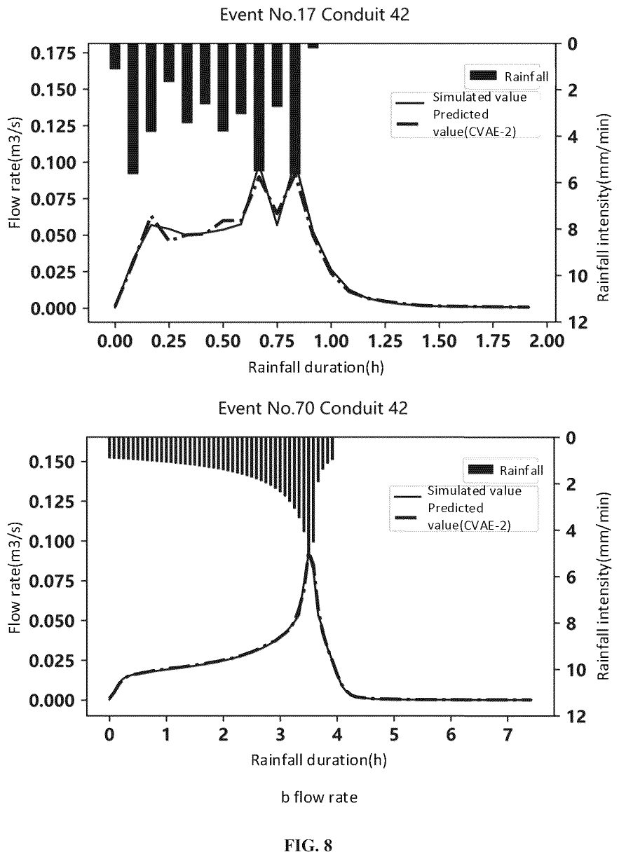

FIG. 7-FIG. 8 are the training effect evaluation diagrams of the rainwater system water depth and flow generation model in the embodiment of the invention, it describes the comparison between the reconstructed water depth (flow) and the simulated value of the model at some nodes (pipelines) in the test of Rainfall example 17 and Rainfall example 70, and reflects the water depth and flow generation model. The learning ability of the water depth and flow changes caused by different rainfall processes.

The overall performance evaluation of the water depth and flow generation model in the training phase is shown in Table 1:

TABLE 1
Mean NSE score of consistency index between model reconstruction
value and simulation value on the test set

| | | | Remaining node | Remaining |
|---|---|---|---|---|
| | | | water depth | pipeline |
| | Water depth | Flow | of the | flow of the |
| | monitoring | monitoring | rainwater | rainwater |
| | point | point | system | system |
| CVAE-1 | 0.9710 | 0.9779 | — | — |
| CVAE-2 | 0.9777 | 0.9948 | 0.9863 | 0.9383 |

Table 1 showed that the water depth and flow generation model had strong generalization ability on the test set, the model had no obvious bias in the learning of water depth and flow characteristics, and NSE can reach more than 0.9, indicating that the model can achieve high accuracy in predicting the characteristics of each node (pipeline) of the rainwater system.

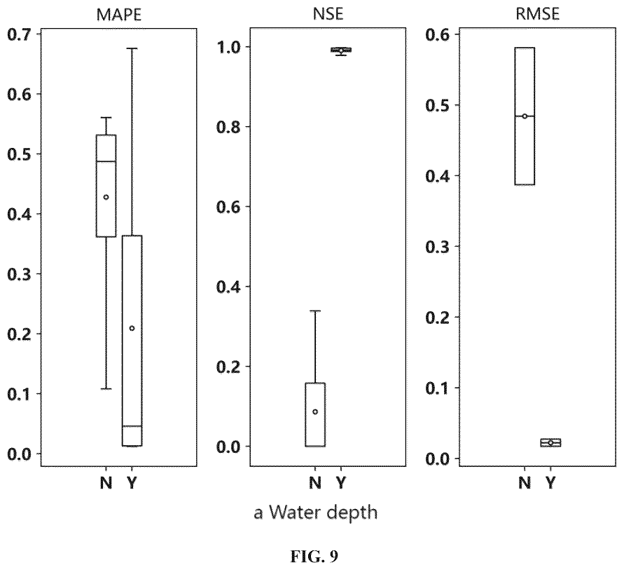

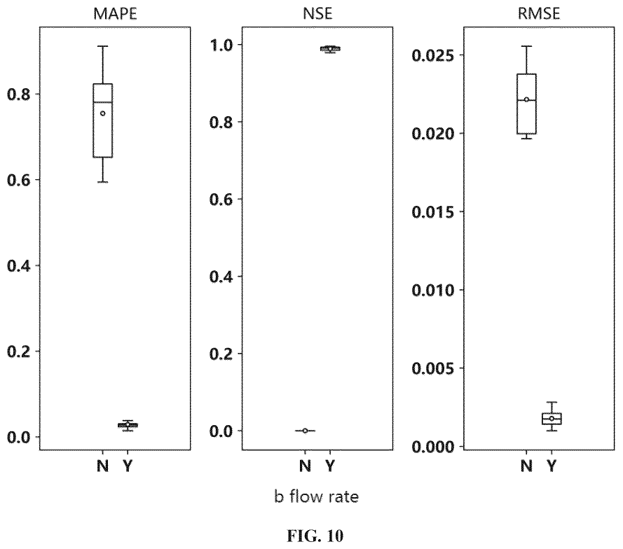

FIG. 9-FIG. 10 is an evaluation box diagram of the update effect of the water depth and flow generation model in the embodiment of the invention. As shown in FIG. 9-FIG. 10, the prediction accuracy of the updated model had been greatly improved in both water depth and flow, and the average MAPE of the updated model for flow prediction was only 2.7%, the average MAPE of the water depth prediction was slightly higher than that of the flow prediction, at about 5%, the average deviation of the water depth predicted by the model compared with the monitoring value was 0.02 m, and the NSE of the water depth and flow prediction was higher than 0.99.

In S120, the error compensation in the flood depth compensation model included:

If the model prediction error of the flood depth of each point in the connected flooded area was consistent, the error term between the flood depth of the flood depth monitoring point and the output of the urban flooding prediction model RP-SN was compensated to the simulation results of each flooded point, and the preliminary compensated inundation map of the flood depth monitoring point was obtained.

The flood borderline of the preliminary compensated inundation map was re-determined, and the secondary compensation was made for the borderline points.

The compensation results of the error terms of different flood depth monitoring points at any flooded point were weighted and summed to estimate the final compensated urban flooding inundation map.

In a specific example, firstly, a flood depth monitoring point p was taken as an example, coordinate (a, b), the measured flood depth value of t time step was recorded as fₚ^{t}, the flood depth output of the model was Output^{t}(a, b), and the error term between the measured value and the output value was Eₚ^{t}=fₚ^{t}−Output^{t}(a, b). Assuming that the model prediction errors of the flood depth at each point in the connected flooded area were consistent, the error term of the flood depth monitoring point p was compensated to the simulation result Output^{t}(x,y) of each flooded point (x,y), and the preliminary compensated inundation depth Sₚ^{t}(x, y)=Output^{t}(x, y)+Eₚ^{t} of the flood depth monitoring point p was obtained. When the error term Eₚ^{t}<0, there might be a negative value in Sₚ^{t}(x, y), and the negative value was zeroed.

In the initial error compensation, the positive and negative of the error item Eₚ^{t} of the flood depth monitoring point p determined that the flood borderline will have two changes of borderline expansion or contraction, it is necessary to re-determine the flood borderline and make secondary compensation for the borderline.

When Eₚ^{t}<0, the internal field (a, b) of (x,y) was traversed. If there was a compensated inundation depth value Sₚ^{t}(a, b)>0 in the internal field, the flood borderline remained unchanged. If the flood depth in all internal fields of the borderline point (x, y) is 0, the borderline shrinks. When Eₚ^{t}>0, the water depth processing method of the flood borderline was divided into the following two cases according to the positive and negative of the relative elevation Δh:

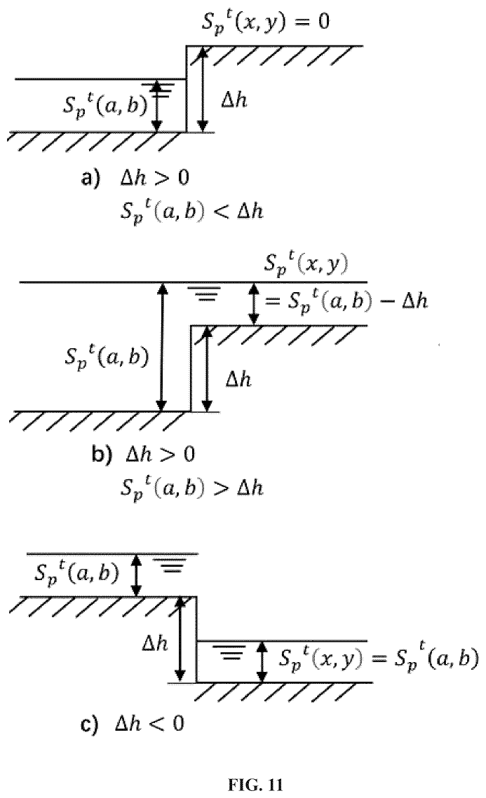

FIG. 11 is the schematic diagram of the flood borderline treatment in the flood depth compensation model in the embodiment of the invention; as shown in FIG. 11, the borderline point coordinate is (x,y), the internal field point coordinate is (a, b), and the relative elevation is Δh=DEM(x, y)−DEM(a, b).
(1) When Δh>0, if the flood depth value Sₚ^{t}(a, b) after compensation of any internal field of the borderline was less than the relative elevation Δh, the borderline point was not flooded, Sₚ^{t}(x, y)=0; if there is an internal domain point Sₚ^{t}(a, b)>Δh, the borderline (x,y) was flooded, at this time, it is assumed that the newly generated flooded point was consistent with the water surface elevation of its internal domain point, the flood depth is Sₚ^{t}(x, y)=Sₚ^{t}(a, b)−Δh, and the flood borderline was updated.
(2) When Δh<0, if the basic assumption of consistent water height (Sₚ^{t}(x, y)=Sₚ^{t}(a, b)−Δh) was followed, the compensated inundation depth Sₚ^{t}(x,y) was prone to a maximum value. Therefore, since the flood depth value near the borderline was generally very small, it can be approximately considered that the flood depth value at the borderline was consistent with the flood depth value in the internal field, that is, Sₚ^{t}(x, y)≈Sₚ^{t}(a, b).

The flood borderline was processed according to the rules of the above secondary compensation until the compensation result tended to be stable and no new borderline points were generated.

It should be noted that due to the limited number of flood depth monitoring points on the ground, and the connectivity of the flooded area was easily affected by rainfall, it was unrealistic to arrange flood depth monitoring points on the ground in each connected area. Therefore, the error terms of several flood depth monitoring points were arranged to compensate for any flooded points, and the weighted sum was made to approximately estimate the final compensated urban flooding inundation map.

The calculation process of the weighted sum was as follows:

The Manhattan distance from any flooded point (x,y) to the flood depth monitoring point set M_{F}={1, 2, . . . N_{f}} in each flood depth monitoring point p(xₚ, yₚ) was recorded as {L₁(x, y), L₂(x, y), . . . , L_{P}(x, y)};

$${L}_{p} ( x , y ) = \vert x - {x}_{p} \vert + \vert y - {y}_{p} \vert \qquad ( 4 )$$

When the coordinate point (x, y) is closer to the flood depth monitoring point p, the compensation flood depth value will be more affected by the error term of the flood depth monitoring point. Therefore, the reciprocal consistency of Manhattan distance

$${\{ {L}_{p} ( x , y ) \}}_{p = 1}^{P}$$

was performed, where Lₚ⁻¹(x, y) was the weight ωₚ(x, y) of the final compensation result S^{t}(x,y) at the flooded point of the error compensation result Sₚ^{t}(x,y) of the flood depth monitoring point p to the coordinate point (x, y). According to the calculated weight, the error compensation results under each flood depth monitoring point were weighted and summed, the weighted sum S^{t}(x, y) of the information of each flood depth monitoring point was the flood depth value generated at the coordinates of (x, y) at time t:

$${S}^{t} ( x , y ) = \frac{{\sum }_{p = 1}^{P} {ω}_{p} ( x , y ) \cdot {{S}_{p}}^{t} ( x , y )}{{\sum }_{p = 1}^{P} {ω}_{p} ( x , y )} \qquad ( 5 )$$

For example, the error terms of the flood depth monitoring points f2 and f3 were used to construct the flood depth compensation model, and the reliability of the error compensation method was verified by the comparison between the compensation value and the observation value of the model at the flood depth monitoring point f1.

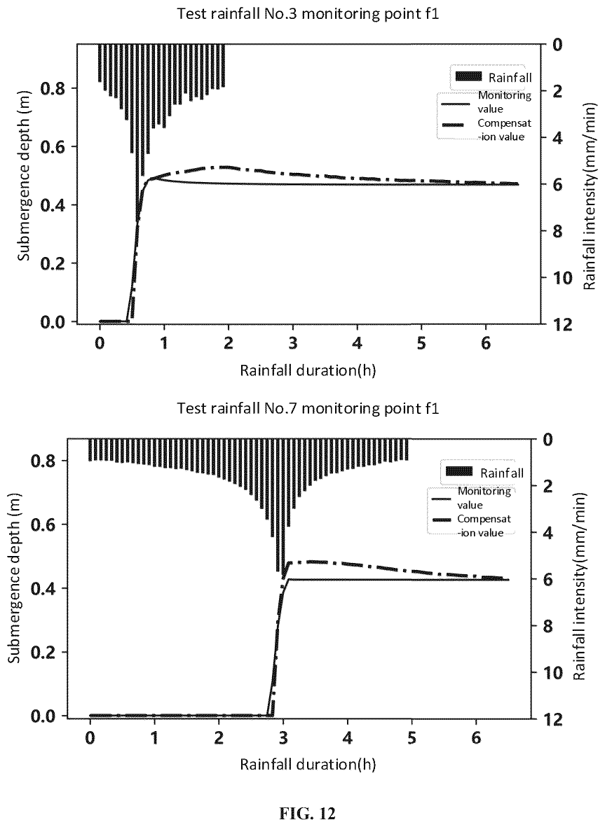

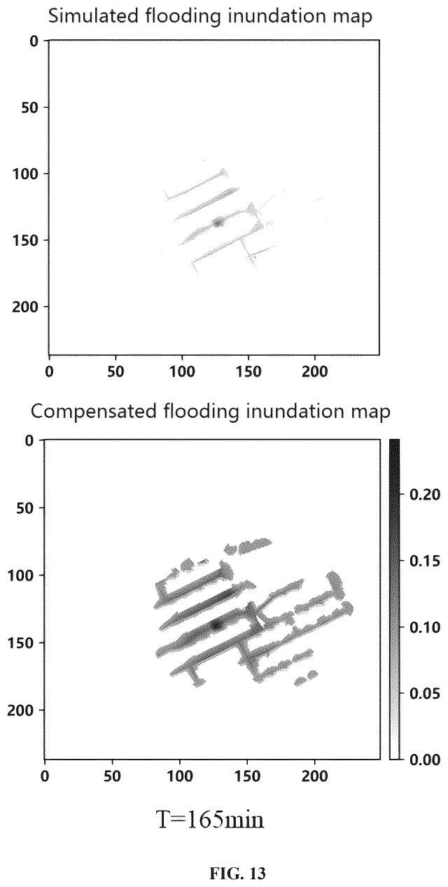

FIG. 12 is the comparison diagram between the compensated inundation depth and the observed value at the flood depth monitoring point f1 in Rainfall example 3 and Rainfall example 7 in the embodiment of the invention; FIG. 13 is the comparison diagram between the compensated urban flooding inundation map and the simulation map at some moments in the updated dataset of Rainfall example 7 of the embodiment of the invention;

In S130, the rationality check of the generated 1D and 2D labels was first performed and compared with the historical data set, that is, the label check results in the simulated data set. The corresponding relationship between the 1D node water depth reconstructed by the water depth and flow generation model and the 2D flood depth generated by the flood depth compensation model at this node was as follows: If the water depth was higher than the difference between the ground elevation and the inner bottom elevation of the node (i.e., the maximum depth of the node), the node was considered to have an overflow, then the ground 2D label of the corresponding coordinate of the node should be flooded; similarly, if the flood depth at the node coordinate was 0, then the node should have no overflow, showing that the water depth of the node was less than the maximum depth of the node. Here, 1D To 2D and 2D To 1D indicators were selected to describe the proportion of correct classification of overflow and non-overflow points. The calculation formula for each index was as follows:

$$\begin{matrix}( 1 ) 1 D To 2 D & \\ {Space}_{e} = \frac{coordinate number of the overflow node corresponding to the ground water in Rainfall e}{overflow node number in Rainfall e} & ( 6 )\end{matrix}$$

$${Time}_{e}^{t} = \frac{coordinate number of the overflow node corresponding to the ground water in Rainfall e at Time t}{overflow node number in Rainfall e at Time t} \qquad ( 7 )$$

$$\begin{matrix}( 2 ) 2 D To 1 D & \\ {Space}_{e} = \frac{non - overflow node number in Rainfall e}{total number of nodes with no water accumulation on the ground in Rainfall e} & ( 8 )\end{matrix}$$

$${Time}_{e}^{t} = \frac{non - overflow node number in Rainfall e at Time t}{total number of nodes with no water accumulation on the ground in rainfall e at Time t} \qquad ( 9 )$$

The label rationality check results were shown in Table 2:

TABLE 2
1D and 2D label matching accuracy

| | | |
|---|---|---|
| Label pair | (Sim1D, Sim2D) | (Rec1D, Err2D) |

| | | | |
|---|---|---|---|
| 1DTo2D | Space | 0.7941 | 0.4238 |
| | Time | 0.8465 | 0.5891 |
| 2DTo1D | Space | 0.9837 | 0.8804 |
| | Time | 0.9845 | 0.8306 |

In Table 2, the label pair denoted the 1D and 2D data sources for calculating the matching degree; Sim1D and Sim2D indicated that the node water depth and flood depth data were derived from the mechanism model simulation results. Rec1D referred to the reconstructed water depth data updated by the water depth and flow generation model of the rainwater system, and Err2D was the flood depth data obtained by the error compensation of the flood depth monitoring point. Where the matching accuracy of the simulated data label pair was considered to be the allowable error in the hydraulic simulation process, which was used to compare the rationality of the generated label. The third column of the third row in the table showed the overflow nodes in the simulated data, and the average proportion of correct classification in the simulated urban flooding inundation map was 0.8465. The fourth column of the fifth row indicates that on the time and space scales, the average proportion of nodes classified as no water accumulation in the 2D compensation graph judged as non-overflow in the 1D reconstruction is 0.8306. According to the accuracy scores of the third and fourth columns in the above table, when judging the non-flooded state, the corresponding relationship between the modified 1D and 2D labels in time and space was similar to the simulated state, and the accuracy was higher than 80%. When judging the overflow or flooded state, the matching accuracy between the corrected labels was low.

It should be noted that if the reliability of the reconstruction result of the water depth and flow generation model was higher than that of the urban flooding inundation map of the error compensation of the flood depth monitoring point, the unreasonable labels in the above inspection process were reprocessed. Specific as follows:
(1) Selecting the liquid site: The 1D water depth reconstructed in the water depth and flow generation model was traversed, if overflow appeared in this node and the point in the compensation map did not accumulate water, the node was added to the node sampling space of the flood depth compensation process.
(2) The correction coefficient of the node was calculated from the simulation data, and the overflow part of the node reconstruction result was corrected to obtain the flood depth value at the ground coordinate of the node.

Taking the node k as an example, in the data set, the average proportional relationship between the simulated water depth value when there was an overflow in the rainwater system node after deducting the maximum depth of the node and the simulated flood depth value corresponding to the ground coordinate at the moment was taken as the correction coefficient α^{(k)} of the node:

$${α}^{( k )} = \overline{{\sum }_{e} {\sum }_{t} \frac{{f}_{t}^{ι , j} ( e )}{{d}_{t}^{k} ( e ) - max {d}^{k}}} if {d}_{t}^{k} ( e ) - max {d}^{k} > 0 \qquad ( 10 )$$

where

$${d}_{t}^{k} ( e )$$

denotes the water depth simulation value of the t-th time step node k in the training sample e, the unit is m; maxd^{k} denotes the maximum depth of node k (ground elevation-inner base elevation), the unit is m;

$${f}_{t}^{i , j} ( e )$$

denotes the simulated flood depth at node k corresponding to ground (i, j), the unit is m.

Then, the water depth of the reconstructed t-th time step node k was recorded as

$${\hat{d}}_{t}^{k} , if {\hat{d}}_{t}^{k} > max {d}^{k} ,$$

and the flood depth compensated at the corresponding coordinate at this time was

$${\hat{f}}_{t}^{i , j} = 0 ,$$

then the flood depth at the corrected liquid node k was

$${\hat{f}}_{t}^{i , j} = {α}^{( k )} \cdot ( {\hat{d}}_{t \cdot Δ t}^{k} - max {d}^{k} ) .$$

(3) The error compensation process of the 2D urban flooding inundation map was repeated and the compensation map was corrected.

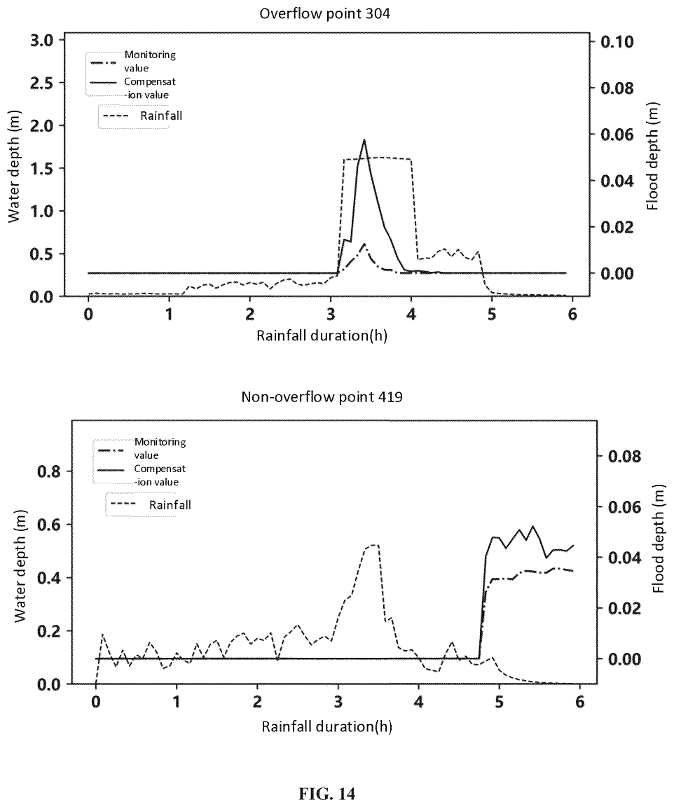

FIG. 14 is the comparison diagram of the 1D water depth reconstruction value of some overflow points and non-overflow points in the embodiment of the invention and the 2D flood depth compensation value and fusion value at the ground corresponding to the node; as shown in FIG. 14, in the process of 1D and 2D label fusion, the reprocessing of the compensated inundation depth makes the flood depth change at the overflow point coincide with the time when the water depth at the overflow point reaches the maximum depth, and finally the purpose of label matching can be achieved. The non-overflow point is affected by the overflow of the upstream node, and may also show a flooded state, at this time, the trend of the flood depth fusion value and the trend of the compensation value at the node are basically the same, indicating that the label fusion does not significantly affect the error compensation result.

In S140, a new data set was generated according to the label and forecast rainfall, the historical data set, that is, the simulated data set, was systematically sampled, and the new data set was repeatedly sampled, the systematic sampling results are mixed with the repeated sampling results to obtain a mixed data set. Where the proportion of old and new data samples in the mixed data set was about 1:1, which could avoid the catastrophic forgetting of the knowledge learned by the old model and take into account the performance of the model on the old data set. Then, the structure and initial weight of the urban flooding prediction model RP-SN were retained by using the continuous learning model updating strategy, and the parameters of the urban flooding prediction model RP-SN were updated on the mixed data set.

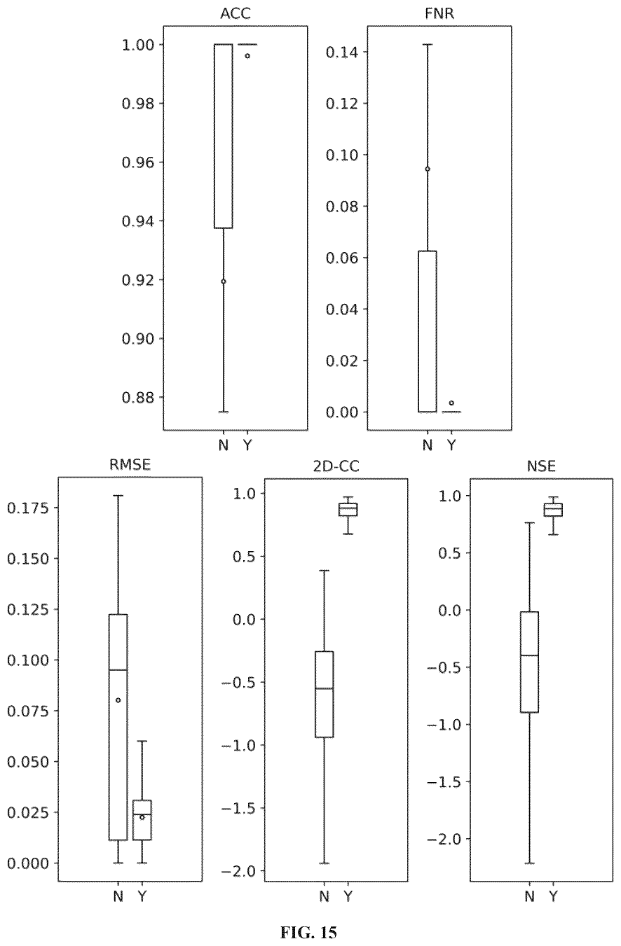

FIG. 15 is the evaluation box diagram of the effect comparison before and after the RP-SN parameter update of the urban flooding prediction model in the embodiment of the invention; as shown in FIG. 15, Y denotes after correction, N denotes before correction, and the box from left to right denotes the consistency between the predicted flood depth and the monitoring value of the model before and after the correction at the flood depth monitoring point under the indexes of ACC, FNR, RMSE, 2D-CC and NSE, where ACC denotes the accuracy, FNR denotes the false negative rate, RMSE denotes the root mean square error, 2D-CC denotes the spatial Pearson correlation coefficient, and NSE denotes Nash-Sutcliffe efficiency coefficient.

The accuracy of the corrected model in the urban flooding inundation judgment task had been significantly improved, and the false negative rate had been reduced to less than 1%. In the flood depth prediction task, the prediction accuracy of the model for the spatial urban flooding inundation map 2D-CC reached 0.9, and the prediction accuracy of the trend change at each flooded point NSE was also close to 0.9, on the whole, the average deviation RMSE of the prediction results of the corrected model was reduced from 0.08 m to 0.03 m in time and space scales compared with that before the correction.

In S150, the urban flooding inundation map was predicted by using the urban flooding prediction model with updated parameters to complete the urban flooding prediction, and the early warning level of the urban flooding was determined according to the prediction result of the urban flooding.

In S160, the drainage scheme was generated according to the early warning level of the urban flooding, and the corresponding drainage facility was regulated according to the drainage scheme. For example, the opening and closing of the gate at the water outlet were adjusted.

According to the embodiment of the invention, at least the following technical effects are achieved:

The invention updates the parameters of the urban flooding prediction model by continuously supplementing new training data, and uses the updated urban flooding prediction model to predict the urban flooding in real time, so that the urban flooding prediction results of the urban flooding prediction model are more suitable for the actual observation situation, and then the early warning level of the urban flooding is determined based on the urban flooding prediction results, so as to generate the drainage scheme, and the corresponding drainage facility is regulated according to the scheme to improve the urban flooding prevention effect. The invention constructs a global inversion model based on the observation data of the rainwater system, the structure and update strategy of the water depth and flow generation model provide a feasible idea for solving the problem of input or label missing of the neural network, and provide data support for the applicability of the subsequent data-driven model in dealing with the label completion problem, the invention uses continuous training and mixed data sets as the update strategy, which can not only ensure the update efficiency, but also avoid catastrophic forgetting.

It should be noted that the above embodiments of each method are expressed as a series of action combinations for a brief description, but technicians in this field should know that the invention is not limited by the sequence of actions described, because according to the invention, some steps can be performed in other sequences or at the same time. Secondly, technicians in this field should also know that the embodiments described in the instructions are optional embodiments, and the actions and modules involved are not necessarily necessary for the invention.

The above is an introduction to the embodiments of the method, and the following is a further explanation of the scheme described in the invention through the embodiment of the device.

FIG. 16 is the structural diagram of the urban flooding prevention device provided by the embodiment of the invention; as shown in FIG. 16, the urban flooding prevention device can include:

The first construction module 1610, the first construction module is used to construct the water depth and flow generation model of the rainwater system, based on the water depth and flow generation model of the rainwater system, the global water depth and the global flow of the rainwater system are inverted according to the forecast rainfall and the water depth of the rainwater system water depth monitoring point and the flow of the flow monitoring point.

The second construction module 1620, the second construction module is used to construct the flood depth compensation model, based on the flood depth compensation model, combined with the flood depth of the flood depth monitoring point at the monitoring time and the output of the trained urban flooding prediction model, the urban flooding inundation map and the binary flooded grid at the monitoring time are generated.

The third construction module 1630, the third construction module is used to construct the generated data fusion model, based on the generated data fusion model, the rationality check for the global water depth and urban flooding inundation map and the binary flooded grid of the rainwater system is performed, and the fusion processing based on the hydraulic connection between the 1D node and the 2D ground is performed to obtain the label.

The parameter update module 1640, the parameter update module is used to generate the new data set according to the label and forecast rainfall, the historical data set and the new data set are mixed to obtain the mixed data set, and the parameters of the urban flooding prediction model are updated on the mixed data set;

The urban flooding warning module 1650, the urban flooding warning module is used to predict urban flooding by using the urban flooding prediction model with updated parameters, and the early warning level of the urban flooding is determined according to the prediction result of the urban flooding;

The facility regulating module 1560, the facility regulating module is used to generate the drainage scheme according to the early warning level of the urban flooding, and to regulate the corresponding drainage facility according to the drainage scheme.

Understandably, each module/unit in the urban flooding prevention device shown in FIG. 16 has the function of realizing each step in the urban flooding prevention method shown in FIGS. 1-2, and can achieve its corresponding technical effect. For simplicity, it is not repeated here.

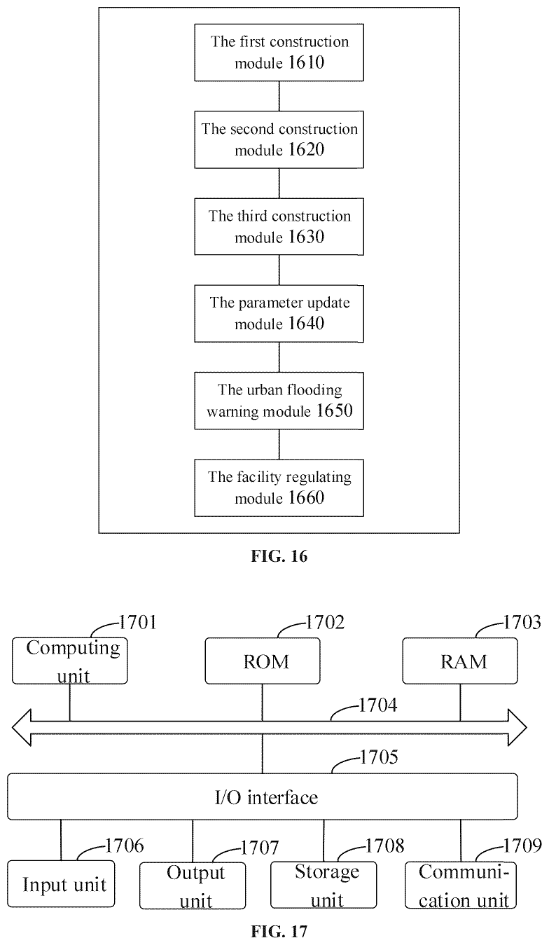

FIG. 17 is a structural diagram of an exemplary electronic device that can implement the embodiment of the invention provided by the embodiment of the invention, as shown in FIG. 17, the electronic device may include a computing unit 1701, which can perform various appropriate actions and processing based on a computer program stored in read-only memory (ROM) 1702 or loaded from memory unit 1708 into random access memory (RAM) 1703. In RAM1703, various programs and data required for the operation of electronic devices can be stored. The computing unit 1701, ROM1702, and RAM1703 are connected through the bus 1704, and the input/output (I/O) interface 1705 is also connected to the bus 1704.

Multiple components in the electronic device are connected to the I/O interface 1705, including: an input unit 1706, such as a keyboard, mouse, etc.; an output unit 1707, such as various types of displays, speakers, etc.; a storage unit 1708, such as disks, CDs, etc.; and a communication unit 1709, such as network card, modem, wireless communication transceiver, etc. The communication unit 1709 allows electronic devices to exchange information/data with other devices through computer networks such as the Internet and/or various telecommunication networks.

The computing unit 1701 can be a variety of general and/or special processing components with processing and computing capabilities. Some examples of the computing unit 1701 include but are not limited to a central processing unit (CPU), graphics processing unit (GPU), various dedicated artificial intelligence (AI) computing chips, various computing units running machine learning model algorithms, digital signal processor (DSP), and any appropriate processor, controller, microcontroller, etc. The computing unit 1701 performs the method and the process described above. For example, in some embodiments, the method can be implemented as a computer program product, including a computer program that is physically contained in a computer-readable medium, such as a storage unit 1708. In some embodiments, part or all of a computer program can be loaded and/or installed on an electronic device via ROM1702 and/or communication unit 1709. When the computer program is loaded into RAM1703 and executed by the computing unit 1701, one or more steps of the method described above can be performed. Alternatively, in other embodiments, computing unit 1701 can be configured as an execution method by any other appropriate means (e.g., with the help of firmware).

It should be understood that you can use the various forms of processes shown above to reorder, add, or delete steps. For example, the steps recorded in the invention can be executed in parallel, in sequence, or in different orders. As long as the desired results of the technical scheme disclosed in the invention can be achieved, this paper does not limit them here.

The above specific implementation methods do not constitute a restriction on the scope of protection of the invention. Technical personnel in this field should understand that according to design requirements and other factors, various modifications, combinations, sub-combinations, and substitutions can be made. Any modification, equivalent replacement, and improvement within the spirit and principles of the invention should be included in the scope of protection of the invention.

What is claimed is:

1. An urban flooding prevention method, comprising:
constructing a water depth and flow generation model of a rainwater system, and based on the water depth and flow generation model of the rainwater system, inverting a global water depth and a global flow of the rainwater system according to a forecast rainfall, a water depth of a water depth monitoring point and a flow of a flow monitoring point;
constructing a flood depth compensation model, and based on the flood depth compensation model, combined with a flood depth of a flood depth monitoring point at a monitoring time and an output of a trained urban flooding prediction model, generating an urban flooding inundation map and a binary flooded grid at the monitoring time;
constructing a generated data fusion model, and based on the generated data fusion model, performing a rationality check for the global water depth, the urban flooding inundation map and the binary flooded grid of the rainwater system, and performing a fusion processing based on a hydraulic connection between a 1D node and a 2D ground to obtain a label;
according to the label and the forecast rainfall, generating a new data set, and mixing a historical data set and the new data set to obtain a mixed data set, updating parameters of the trained urban flooding prediction model on the mixed data set;
using the trained urban flooding prediction model with updated parameters to predict an urban flooding, and determining an early warning level of the urban flooding according to a prediction result of the urban flooding; and
according to the early warning level of the urban flooding, generating a drainage scheme, and regulating a corresponding drainage facility according to the drainage scheme.

2. The urban flooding prevention method according to claim 1, wherein the step of constructing the water depth and flow generation model of the rainwater system comprises:
based on a conditional variational autoencoder and a similarity representation, constructing the water depth and flow generation model of the rainwater system; wherein the water depth and flow generation model comprises two conditional variational autoencoders, denoted as CVAE-1 and CVAE-2, respectively, with consistent network structure, and a definition of the similarity representation is that encoders in CVAE-1 and CVAE-2 learn similar coding representations in a same rainfall event;
an update strategy in the water depth and flow generation model of the rainwater system comprises:
updating CVAE-1 according to the forecast rainfall and the water depth of the water depth monitoring point and the flow of the flow monitoring point, and obtaining the coding representation of CVAE-1; and
expressing a coding of CVAE-1 as a coding constraint of CVAE-2, and updating CVAE-2 iteratively, comprising: inputting the coding representation of CVAE-1 as the coding constraint of CVAE-2 into a decoder after an initialization weight is loaded in CVAE-2 to generate a predicted value, so as to complete an initial label under the forecast rainfall and serve as an input of a next iteration step.

3. The urban flooding prevention method according to claim 1, wherein an error compensation in the flood depth compensation model comprises:
when a model prediction error of the flood depth of each point in a connected flooded area is consistent, compensating an error term between the flood depth of the flood depth monitoring point and the output of the trained urban flooding prediction model to a simulation result of each flooded point, and obtaining a preliminary compensated urban flooding inundation map of the flood depth monitoring point;
re-determining a flood borderline of the preliminary compensated urban flooding inundation map, and performing a secondary compensation for borderline points; and
weighting and summing compensation results of error terms of different flood depth monitoring points at any flooded point to estimate a final compensated urban flooding inundation map.

4. The urban flooding prevention method according to claim 1, wherein the rationality check in the generated data fusion model comprises:
checking a corresponding relationship between a water depth of the 1D node reconstructed by the water depth and flow generation model and a 2D flood depth at the node generated by the flood depth compensation model, comprising:
when the water depth of the node is higher than a maximum depth of the node, it is considered an overflow in the node, and a ground 2D label of a corresponding coordinate of the node should be flooded; and when a flood depth at a node coordinate is 0, no overflow should be in the node, showing that the water depth of the node is less than the maximum depth of the node.

5. The urban flooding prevention method according to claim 1, wherein the step of mixing the historical data set and the new data set to obtain the mixed data set comprises:
performing a systematic sampling for the historical data set and a repeated sampling for the new data set; and
mixing a systematic sampling result with a repeated sampling result to obtain the mixed data set.

6. The urban flooding prevention method according to claim 1, wherein the step of updating parameters of the trained urban flooding prediction model on the mixed data set comprises:
retaining a structure and an initial weight of the trained urban flooding prediction model by using a continuous learning model updating strategy, and updating the parameters of the trained urban flooding prediction model on the mixed data set.

7. An urban flooding prevention apparatus, comprising:
a first construction module, wherein the first construction module is configured to construct a water depth and flow generation model of a rainwater system, based on the water depth and flow generation model of the rainwater system, a global water depth and a global flow of the rainwater system are inverted according to a forecast rainfall, a water depth of a water depth monitoring point and a flow of a flow monitoring point;
a second construction module, wherein the second construction module is configured to construct a flood depth compensation model, based on the flood depth compensation model, combined with a flood depth of a flood depth monitoring point at a monitoring time and an output of a trained urban flooding prediction model, an urban flooding inundation map and a binary flooded grid at the monitoring time are generated;
a third construction module, wherein the third construction module is configured to construct a generated data fusion model, and based on the generated data fusion model, a rationality check for the global water depth, the urban flooding inundation map and the binary flooded grid of the rainwater system is performed, and a fusion processing based on a hydraulic connection between a 1D node and a 2D ground is performed to obtain a label;
a parameter update module, wherein the parameter update module is configured to generate a new data set according to the label and the forecast rainfall, a historical data set and the new data set are mixed to obtain a mixed data set, and parameters of the trained urban flooding prediction model are updated on the mixed data set;
an urban flooding warning module, wherein the urban flooding warning module is configured to predict an urban flooding by using the trained urban flooding prediction model with updated parameters, and an early warning level of the urban flooding is determined according to a prediction result of the urban flooding; and
a facility regulating module, wherein the facility regulating module is configured to generate a drainage scheme according to the early warning level of the urban flooding, and to regulate a corresponding drainage facility according to the drainage scheme.

8. An electronic device, comprising: at least one processor, and a memory communicating with the at least one processor; wherein the memory stores an instruction executable by the at least one processor, and the instruction is executed by the at least one processor to enable the at least one processor to perform the urban flooding prevention method according to claim 1.

9. A non-instantaneous computer readable storage medium, storing a computer instruction, wherein the computer instruction is configured to enable a computer to perform the urban flooding prevention method according to claim 1.

10. The electronic device according to claim 8, wherein in the urban flooding prevention method, the step of constructing the water depth and flow generation model of the rainwater system comprises:
based on a conditional variational autoencoder and a similarity representation, constructing the water depth and flow generation model of the rainwater system; wherein the water depth and flow generation model comprises two conditional variational autoencoders, denoted as CVAE-1 and CVAE-2, respectively, with consistent network structure, and a definition of the similarity representation is that encoders in CVAE-1 and CVAE-2 learn similar coding representations in a same rainfall event;
an update strategy in the water depth and flow generation model of the rainwater system comprises:
updating CVAE-1 according to the forecast rainfall and the water depth of the water depth monitoring point and the flow of the flow monitoring point, and obtaining the coding representation of CVAE-1; and
expressing a coding of CVAE-1 as a coding constraint of CVAE-2, and updating CVAE-2 iteratively, comprising: inputting the coding representation of CVAE-1 as the coding constraint of CVAE-2 into a decoder after an initialization weight is loaded in CVAE-2 to generate a predicted value, so as to complete an initial label under the forecast rainfall and serve as an input of a next iteration step.

11. The electronic device according to claim 8, wherein in the urban flooding prevention method, an error compensation in the flood depth compensation model comprises:
when a model prediction error of the flood depth of each point in a connected flooded area is consistent, compensating an error term between the flood depth of the flood depth monitoring point and the output of the trained urban flooding prediction model to a simulation result of each flooded point, and obtaining a preliminary compensated urban flooding inundation map of the flood depth monitoring point;
re-determining a flood borderline of the preliminary compensated urban flooding inundation map, and performing a secondary compensation for borderline points; and
weighting and summing compensation results of error terms of different flood depth monitoring points at any flooded point to estimate a final compensated urban flooding inundation map.

12. The electronic device according to claim 8, wherein in the urban flooding prevention method, the rationality check in the generated data fusion model comprises:
checking a corresponding relationship between a water depth of the 1D node reconstructed by the water depth and flow generation model and a 2D flood depth at the node generated by the flood depth compensation model, comprising:
when the water depth of the node is higher than a maximum depth of the node, it is considered an overflow in the node, and a ground 2D label of a corresponding coordinate of the node should be flooded; and when a flood depth at a node coordinate is 0, no overflow should be in the node, showing that the water depth of the node is less than the maximum depth of the node.

13. The electronic device according to claim 8, wherein in the urban flooding prevention method, the step of mixing the historical data set and the new data set to obtain the mixed data set comprises:
performing a systematic sampling for the historical data set and a repeated sampling for the new data set; and
mixing a systematic sampling result with a repeated sampling result to obtain the mixed data set.

14. The electronic device according to claim 8, wherein in the urban flooding prevention method, the step of updating parameters of the trained urban flooding prediction model on the mixed data set comprises:
retaining a structure and an initial weight of the trained urban flooding prediction model by using a continuous learning model updating strategy, and updating the parameters of the trained urban flooding prediction model on the mixed data set.

15. The non-instantaneous computer readable storage medium according to claim 9, wherein in the urban flooding prevention method, the step of constructing the water depth and flow generation model of the rainwater system comprises:
based on a conditional variational autoencoder and a similarity representation, constructing the water depth and flow generation model of the rainwater system; wherein the water depth and flow generation model comprises two conditional variational autoencoders, denoted as CVAE-1 and CVAE-2, respectively, with consistent network structure, and a definition of the similarity representation is that encoders in CVAE-1 and CVAE-2 learn similar coding representations in a same rainfall event;
an update strategy in the water depth and flow generation model of the rainwater system comprises:
updating CVAE-1 according to the forecast rainfall and the water depth of the water depth monitoring point and the flow of the flow monitoring point, and obtaining the coding representation of CVAE-1; and
expressing a coding of CVAE-1 as a coding constraint of CVAE-2, and updating CVAE-2 iteratively, comprising: inputting the coding representation of CVAE-1 as the coding constraint of CVAE-2 into a decoder after an initialization weight is loaded in CVAE-2 to generate a predicted value, so as to complete an initial label under the forecast rainfall and serve as an input of a next iteration step.

16. The non-instantaneous computer readable storage medium according to claim 9, wherein in the urban flooding prevention method, an error compensation in the flood depth compensation model comprises:
when a model prediction error of the flood depth of each point in a connected flooded area is consistent, compensating an error term between the flood depth of the flood depth monitoring point and the output of the trained urban flooding prediction model to a simulation result of each flooded point, and obtaining a preliminary compensated urban flooding inundation map of the flood depth monitoring point;
re-determining a flood borderline of the preliminary compensated urban flooding inundation map, and performing a secondary compensation for borderline points; and
weighting and summing compensation results of error terms of different flood depth monitoring points at any flooded point to estimate a final compensated urban flooding inundation map.

17. The non-instantaneous computer readable storage medium according to claim 9, wherein in the urban flooding prevention method, the rationality check in the generated data fusion model comprises:
checking a corresponding relationship between a water depth of the 1D node reconstructed by the water depth and flow generation model and a 2D flood depth at the node generated by the flood depth compensation model, comprising:
when the water depth of the node is higher than a maximum depth of the node, it is considered an overflow in the node, and a ground 2D label of a corresponding coordinate of the node should be flooded; and when a flood depth at a node coordinate is 0, no overflow should be in the node, showing that the water depth of the node is less than the maximum depth of the node.

18. The non-instantaneous computer readable storage medium according to claim 9, wherein in the urban flooding prevention method, the step of mixing the historical data set and the new data set to obtain the mixed data set comprises:
performing a systematic sampling for the historical data set and a repeated sampling for the new data set; and
mixing a systematic sampling result with a repeated sampling result to obtain the mixed data set.

19. The non-instantaneous computer readable storage medium according to claim 9, wherein in the urban flooding prevention method, the step of updating parameters of the trained urban flooding prediction model on the mixed data set comprises:
retaining a structure and an initial weight of the trained urban flooding prediction model by using a continuous learning model updating strategy, and updating the parameters of the trained urban flooding prediction model on the mixed data set.
